(19) United States
(12) Patent Application Publication
(10) Pub. No.: US 2008/0086992 A1
(43) Pub. Date: Apr. 17, 2008

(54) Filter Device

(75) Inventor: Stefan Walz, Ludwigsburg (DE)

Correspondence Address: GUDRUN E. HUCKETT DRAUDT, SCHUBERTSTR. 15A, WUPPERTAL, 42289, DE

(73) Assignee: MANNGMBH, Ludwigsburg (DE)

(21) Appl. No.: 11/868,969

(22) Filed: Oct. 9, 2007

(30) Foreign Application Priority Data
Oct. 9, 2006 (DE) 10 2006 048 076.7

(51) Int. Cl. B01D 39/14; B01D 50/00; B05D 5/00

(52) U.S. Cl. 55/385.3; 427/244; 55/527; 977/903

(57) ABSTRACT

A filter device has a filter element made from a filter hose that has a filter wall separating an unfiltered side from a clean side of the filter device in a radial direction. The filter wall of the filter hose is provided with a very fine particle filtration layer comprised of nanofibers. The diameter of the nanofibers is less than one micrometer. The nanofiber layer can be applied to a green filter material and the filter element can be produced subsequently from the filter material with applied nanofiber layer. Alternatively, the nanofiber layer can be applied to a finished filter element.

### BACKGROUND OF THE INVENTION

The invention relates to a filter device, in particular for filtering air in motor vehicles, for example, combustion air of internal combustion engines or air for the passenger compartment. The filter device comprises a filter element embodied as a filter hose whose filterwall separates in a radial direction the raw (unfiltered fluid) side from the clean (filtered fluid) side of the filter element.

US 2007/0131194 A1 discloses an intake filter of an internal combustion engine of a motor vehicle that comprises as a filter element a plurality of filter hoses arranged in the engine compartment of the motor vehicle. The filter hoses are comprised of a flexible filter material and the supplied combustion airflows radially through the filter material from the exterior to the interior. The cleaned or filtered combustion air is supplied from the interior of the filter hoses to an air collecting chamber to which the filter hoses are connected; the air collecting chamber is connected to the cylinder intakes of the internal combustion engine. The filter hoses are protected by a cover. An advantageous feature of this intake filter is that the filter surface area and thus also the filtration efficiency can be adjusted in accordance with the respective requirements of the internal combustion engine in question by appropriate selection of the number and configuration of the filter hoses.

With increasing demands on the performance of modern internal combustion engines, in particular in connection with emission behavior, higher demands are also put on the separation or filtration efficiency of the air filter devices. The proportion of dust particles still passing through the filter device is therefore to be reduced further.

### SUMMARY OF THE INVENTION

It is an object of the present invention to improve with simple measures the separation efficiency of a filter device.

In accordance with the present invention, this is achieved in that the filterwall of the filter hose is provided with a filtration layer for very fine particles which layer is comprised of nanofibers.

The filter device according to the invention has a filter element embodied as a filter hose and the fluid to be cleaned or filtered passes radially through the filter wall of the filter hose. For improving the filtration efficiency or the degree of separation, the filter wall is provided with a very fine particle filtration layer that is comprised of nanofibers. This nanofiber layer can be configured to be very thin so that the total thickness of the filter wall including the nanofiber layer, viewed in the radial direction, is hardly greater than without the very fine particle filtration layer. For example, it can be advantageous to configure the nanofiber layer to be maximally 1/10th of the thickness of the rest of the filter wall wherein optionally also significantly smaller thicknesses of the nanofiber layer can be employed, for example, 1/100th of the filter wall thickness. As a result of the minimal thickness of the nanofiber layer and the relatively minimal density, the total weight of the filter element is practically not increased.

At the same time, the nanofiber layer enables a significant increase of the degree of separation. Advantageously, the nanofiber layer is located at the exit side of the filter wall of the filter hose so that in the flow direction an increasing degree of separation is provided. Large dirt particles will deposit on the intake side of the filter wall while the very fine dirt particles are retained by the nanofiber layer at the exit side of the filter wall.

The nanofibers are expediently manufactured of a fiber material made from polymers; they are comprised, for example, of PES (polyethersulfone), PP (polypropylene), PA (polyamide) or PC (polycarbonate or polyester). The filter material from which the filter walls of the filter hose are made is also expediently made of synthetic material, in particular made from polymers. In principle, filter materials derived from natural materials can be used also, in particular, cellulose-based materials.

According to an advantageous embodiment, it is provided that the filter wall has an increasing density from the intake side toward the exit side. This is advantageously realized with discrete filter layers, in particular, two filter layers; the layer that is facing the intake side is a coarse filtration layer and the layer that is facing the exit side is a fine filtration layer. At the exit side of the fine filtration layer, the very fine particle filtration layer or coating made of nanofibers is provided so that, as a whole, the filterwall is comprised of three layers or plies when viewed in cross-section.

The filter device with the coated filter hose can be used in different constructive embodiments. For example, it is possible to provide the filter hose with folds or pleats whose edges can extend in the longitudinal axial direction, transverse to the axial direction, and/or angularly or slantedly positioned relative to the axial direction. In particular in the last mentioned situation, such a filter hose has high stability and a large filter surface area while, at the same time, the filter hose is flexible in the axial direction as well as in the radial direction. Moreover, an accordion effect can be achieved that enables an automatic return into the initial unloaded position after a deflection of the filter hose has occurred in the axial or radial direction as soon as the external forces no longer act on the filter element.

A filter hose with smooth and fold-free walls also has a significant degree of flexibility, in particular in the transverse direction. This makes it possible to design different geometries of filter devices wherein, as a result of the flexibility, it is possible to achieve a high degree of utilization of identical parts. This means that same filter hoses can be used for different geometries, particularly filter housing geometries.

According to a preferred configuration, the coated filter hose is received in a support pipe of hard or stiff material, in particular plastic material, wherein the inner diameter of the support pipe is greater than the outer diameter of the filter hose so that between the outer wall or periphery of the filter hose and the inner wall or periphery of the support pipe an annular space for the flow of the fluid is provided. The support pipe, depending on the requirements and constructive conditions, can have different courses or extensions which, as a result of the flexibility of the filter hose, can also be realized by the filter hose.

The filter device according to the invention is suitable in particular for the filtration of combustion air for internal combustion engines, preferably for internal combustion engines of commercial vehicles. However, its utilization is not limited to such applications; instead, the filtration of gaseous and optionally also liquid fluids is possible in general.

### BRIEF DESCRIPTION OF THE DRAWING

FIG. 1 is a schematic illustration of the engine compartment of a motor vehicle with a filter device arranged therein for filtration of the combustion air, wherein the filter device is configured as a support pipe with a filter hose arranged therein.

FIG. 2 is a section view of the wall of the filter hose comprising at the intake side a coarse filtration layer and at the exit side a fine filtration layer wherein in addition at the exit side a coating or layer of nanofibers is provided on the fine filtration layer.

FIG. 3 is a perspective illustration of a filter hose having a wall provided with folds or pleats.

### DESCRIPTION OF THE PREFERRED EMBODIMENTS

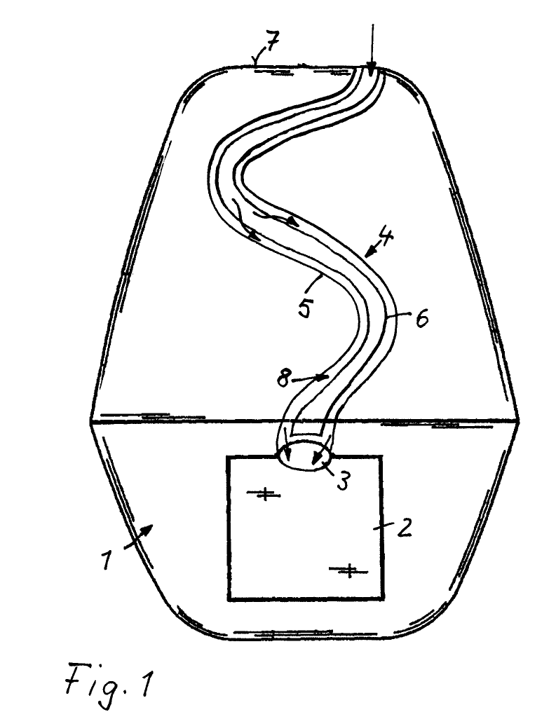

FIG. 1 illustrates the engine compartment 1 of a motor vehicle with internal combustion engine 2 arranged therein. The cylinder intakes of the internal combustion engine 2 are supplied with filtered combustion air through an opening 3; the combustion air is filtered in the filter device 4 arranged upstream of the opening 3. The filter device 4 is comprised of a support pipe 5 that takes on the function of the filter housing and a filter element in the form of a filter hose 6 arranged in the support pipe 5 and extending across the axial length of the support pipe 5. The filter hose 6 in the support pipe 5 has a smaller cross-sectional surface area than the support pipe 5 so that between the outer wall of the filter hose 6 and the inner wall of the support pipe 5 an annular space 8 is provided that extends between the opposite axial end faces of the support pipe 5 and the filter hose 6 and provides a flow chamber for the combustion air. The support pipe 5 with the filter hose 6 extends between the front end 7 of the motor vehicle and the opening 3 that is correlated with the intake passages of the internal combustion engine 2. The combustion air that flows in at the front end 7 of the motor vehicle is introduced axially into the interior of the filter hose 6; the end face opposite the inlet is closed off. The unfiltered combustion air is therefore forced to pass through the filter walls of the filter hose 6 in the radial direction from the interior to the exterior so that dirt particles entrained in the combustion air are separated or filtered out. The clean air flows axially through the annular space 8 or flow chamber provided between the filter hose 6 and the support pipe 5 to the opening 3.

In principle, it is also possible that the flow direction through the filter wall of the filter hose 6 is realized in the opposite direction, i.e., radially from the exterior to the interior. In this case, the annular space 8 is the raw (unfiltered air) side and the interior of the filter hose is the clean (filtered air) side.

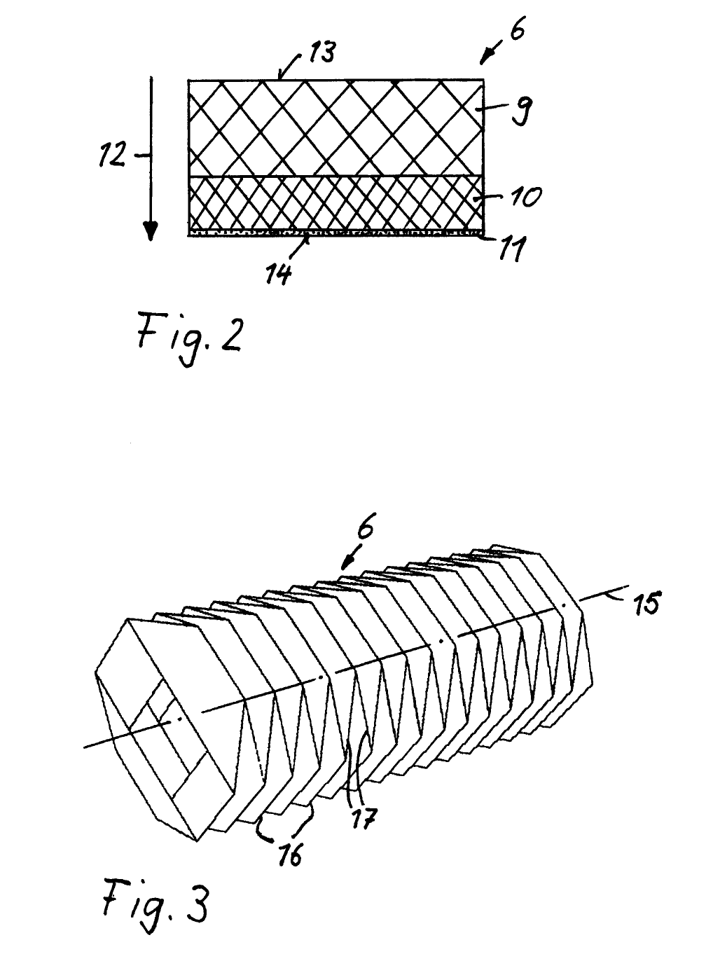

In FIG. 2, the wall of the filter hose 6 is shown in section. The arrow 12 indicates the flow direction, the intake side is identified at 13 and the exit side at 14. The filter wall is of a multi-layer configuration and comprises a coarse filtration layer 9 at the intake side 13 and a fine filtration layer 10 at the exit side 14. This fine filtration layer 10 is provided at the exit side with a very fine particle filtration layer 11 comprised of nanofibers. Accordingly, the filter wall in the flow direction 12 of the fluid to be filtered is of a multi-layer configuration wherein the density or the degree of separation increases from layer to layer. The thickness of the very fine particle filtration layer 11 in comparison to the thickness of the two other layers 9 and 10 is minimal. For example, the thickness of the very fine particle filtration layer 11 is maximally 1/10th, optionally only 1/100th of the thickness of the two layers 9 and 10 together. The diameter of the nanofibers is advantageously less than one micrometer and is in particular in a range from between 50 nm to 500 nm.

In FIG. 3, a filter hose 6 is shown in a perspective view. Its filter wall is configured in the way illustrated in FIG. 2. The filter hose 6 has a plurality of pleats 16 that are distributed about the circumference in the axial direction as well as in the circumferential direction. Some of the pleats 16 have filter edges 17 that, relative to the longitudinal axis 15 of the filter element or to a longitudinal center plane of the filter element, are positioned at an angle, i.e., they extend slantedly relative to the longitudinal axis. In this way, the filter hose has a bellows-like structure imparting high stability and, at the same time, high flexibility in the longitudinal direction as well as in the radial direction.

The filter device according to the present invention is suitable in particular for the filtration of combustion air for internal combustion engines. However, a utilization for air filtration of the passenger compartment or, generally, for filtration purposes in vehicles is possible.

The filter device can be manufactured in that a nanofiber layer is applied onto a green filter material (not yet processed to a finished filter element) and, subsequently, the green filter material with the applied nanofiber layer is processed to produce a finished filter element.

It is also possible that the nanofiber layer is applied onto a finished filter element, i.e., the filter element is first produced to the desired specifications and the nanofiber layer is applied to the finished filter element.

The specification incorporates by reference the entire disclosure of German priority document 10 2006 048 076.7 having a filing date of Oct. 9, 2006.

While specific embodiments of the invention have been shown and described in detail to illustrate the inventive principles, it will be understood that the invention may be embodied otherwise without departing from such principles.

What is claimed is:

1. A filter device comprising:
a filter element comprised of a filter hose having a filter wall separating an unfiltered side from a clean side of the filter device in a radial direction, wherein the filter wall of the filter hose is provided with a very fine particle filtration layer comprised of nanofibers.

2. The filter device according to claim 1, wherein a diameter of the nanofibers is less than one micrometer.

3. The filter device according to claim 1, wherein a diameter of the nanofibers is in a range of between 50 nm to 500 nm.

4. The filter device according to claim 1, wherein the nanofibers are comprised of a fiber material made from a polymer.

5. The filter device according to claim 4, wherein the polymer is selected from the group consisting of PES (polyethersulfone), PP (polypropylene), PA (polyamide), and PC (polycarbonate).

6. The filter device according to claim 1, wherein the very fine particle filtration layer is arranged at an exit side of the filter wall in a flow direction of a fluid to be filtered.

7. The filter device according to claim 1, wherein a thickness of the very fine particle filtration layer is small in comparison to a radial thickness of the filter wall.

8. The filter device according to claim 1, wherein the filter wall has increasing density in a direction from an intake side to an exit side of the filter wall in a flow direction of a fluid to be filtered.

9. The filter device according to claim 8, wherein the filter wall in the radial direction has at least two discrete filter layers, wherein a first one of the at least two filter layers is a coarse filtration layer and faces the intake side and wherein a second one of the at least two filter layers is a fine filtration layer and faces the exit side.

10. The filter device according to claim 1, wherein the filter hose is comprised of synthetic filter material.

11. The filter device according to claim 8, wherein the synthetic filter material is a polymer material.

12. The filter device according to claim 1, further comprising a support pipe, wherein the filter hose is received in the support pipe, wherein between an outer wall of the filter hose and an inner wall of the support pipe an annular space is provided for a flow of a fluid to be filtered.

13. The filter device according to claim 1 in the form of an air filter for an internal combustion engine of a commercial vehicle.

14. A method for producing a filter device according to claim 1, comprising the steps of:
applying a nanofiber layer onto a green filter material; and
subsequently, processing the green filter material with the applied nanofiber layer to a filter element.

15. A method for producing a filter device according to claim 1, comprising the step of applying a nanofiber layer onto a finished filter element.
